(19) United States
(12) Patent Application Publication
(10) Pub. No.: US 2011/0099172 A1
(43) Pub. Date: Apr. 28, 2011

(54) DOCUMENT EXPOSURE TRACKING PROCESS AND SYSTEM

(76) Inventor: Braddock Gaskill, South Pasadena, CA (US)

(21) Appl. No.: 12/603,767

(22) Filed: Oct. 22, 2009

(51) Int. Cl. G06F 17/30

(52) U.S. Cl. 707/741; 707/822; 707/E17.002; 707/E17.005; 707/748

(57) ABSTRACT

A system and process to allow more accurate tracking of attention received by an electronic document via a display screen. The process, and the system that implements the process: maps a machine readable document into data segments; defines a list of data segment indicators corresponding to the data segments; determines a portion of the machine readable document truncated to a occupy view port; and associates an attention value with the data segment indicators corresponding to the presence of the data segments available to the view port. The present invention may further utilize the track list to monitor the availability of machine readable documents, truncated or not, in the view port, and tint the machine readable document accordingly.

### FIELD OF THE INVENTION

The present invention relates to the field of electronic document management and more specifically to the field of monitoring document examination.

### BACKGROUND

An observer may see an individual reading a newspaper and if that observer is particularly astute, may notice the name and section of the newspaper—or perhaps even the page number. However, that same observer would be at a loss to ascertain the particular paragraph currently occupying the reader's time. Without simply asking the reader, only a thorough examination of the reader's pupils would reveal the information currently perceived by the reader. With large electronic documents, the task is simpler; the reader is reading the matter currently occupying space on the computer screen.

The internet has triggered the proliferation of electronic information resources and electronic document repositories. The widespread availability of these electronic resources created a need for the development of technology to record the usage of such resources. For example, researchers, libraries, aggregator services, and publishers can benefit from the ability to track in detail the usage of electronic documents. Jonathan Eaton, Measuring User Statistics, Update Magazine, Chartered Institute of Library and Information Professionals (September 2002). Users of electronic devices often sift through a large set of electronic documents. Those sifted documents may come from a variety of sources, including online databases, a boolean-operator search or any other type of World Wide Web internet search, or a collection maintained on the user's computer hard-drive or other electronic storage medium. The time a user spends on each document may vary, as may the attention given to each document. Multiple entities, including the user, document provider, or some third party, may to track the time and attention allotted to each of the documents in the set of documents.

Basic document tracking methods currently exist. For example, Internet web browsing software tracks a user's webpage visitation history. These browsers provide some useful information such as dates and times that sites were visited. Typically, the history does not track the time that a user spends viewing each document, only whether a document is viewed at all. Another means of document tracking is based on restricted access to documents. By way of example, a publisher may allow users to view abstracts of documents free of charge, and then may permit a user to view the entire document for a flat-rate charge. This method generally does not discriminate by type of usage or extent of usage and the user may be charged for the entire document irrespective of the nature of the use.

Therefore, there is need for a document tracking systems that allow more accurate tracking of document usage by users of electronic devices.

### SUMMARY

The present invention is directed to a process and a system for tracking document exposure. In tracking document exposure, the present invention allows quantification of the specific interactions between a user and document. In particular the present invention tracks the specific portions of a document that a user passively experiences, and preferred embodiments will track active interactions with the document. The document may include any data capable of communicating information, e.g. language, graphics, audio files, and video files.

An embodiment of the process of the present invention includes mapping a machine readable document into finite data segments. The finite data segments may include words, sentences, paragraphs, sections (either lexical or spatial), titles, or any other grammatical/literary division; graphics; audio files; and video files. After mapping the finite data segments, a track list of data segment indicators is defined. The data segment indicators correspond to a specific finite data segment.

As machine readable documents larger than a view port are truncated to fit within the view port, the process determines the portion of the machine readable document available to the view port. Upon determining the portion of the machine readable document available to the view port, the process then identifies the data segments within the view port. The view port of the present invention is the window through which a document is displayed; a view screen, e.g. a computer monitor, may include one or more view ports each displaying a separate document. The data segment indicators corresponding to the data segments within the view port then receive an attention value. The attention value may be any alpha numeric or symbolic device capable of recording a user's passive or active action with the data segments within the view port. Passive actions include activities that do not involve interactions with data segments, such as reading. Active actions include higher level activities in which the user manipulates data, such as copying-and-pasting data.

The principal means of associating an attention value with document exposure includes tracking exposure as a function of time. That is to say, the data segment indicators are altered per unit of time that their respective data segments are available to the view port. The preferred means for tracking document exposure includes updating the track list per frame rate cycle of a monitor.

Other preferred embodiments of the present invention may include modifying a visual representation of the information of the machine readable document in response to an attention value. It is preferred that modifying the visual representation of the machine readable document include color tinting the data segments thereon. A preferred color-tinting embodiment modifies a visual representation on the basis of the user accessing and/or manipulating the document data segments.

Other preferred embodiments may include utilization of the present invention in a rights attribution payment scheme. Steps of the rights attribution scheme may include transmitting a machine readable document to the view port of a user, after which the data segments occupying the user's view port are tracked for an attention value. As the user utilizes the machine readable document, or at some termination point, the user accumulates a fee based on one or more attention values within the track list.

The system of the present invention includes the computer hardware capable of performing the process of the present invention. The system preferably includes one or more view screens (e.g. a computer monitor screen) and an arithmetic logic unit (ALU), e.g. a processor chip.

Therefore, it is an aspect of the present invention to provide a process and system capable of tracking document exposure.

It is a further aspect of the present invention to provide a process and system capable of accurately quantifying document exposure.

It is a further aspect of the present invention to provide a process and system capable of tracking partial document exposure.

It is a further aspect of the present invention to provide a process and system capable of fairly disbursing income among contributors to a joint work.

It is a further aspect of the present invention to provide a process and system capable of allowing editors to ascertain the extent to which portions of a document were previously examined.

It is a further aspect of the present invention to provide a process and system capable of allowing a manager of a collaborative venture to review which venture participants reviewed which documents and which portions of a document.

It is a further aspect of the present invention to provide a process and system capable of enhancing collaboration between team members that rely on shared documents.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a flowchart view of an embodiment of the process of the present invention.

FIG. 2 is a flowchart view of an embodiment of the process of the present invention.

FIG. 3 is a flowchart view of an embodiment of the process of the present invention.

FIG. 4 is a representation of a mapped machine readable document and its corresponding list.

FIG. 5 is a front, plan view of the system of the present invention.

FIG. 6 is a representation of a mapped machine readable document and its corresponding list.

FIG. 7 is a representation of a mapped machine readable document and its corresponding list.

FIG. 8 is a representation of a mapped machine readable document and its corresponding list.

FIG. 9 is a representation of a mapped machine readable document and its corresponding list having color tint indicators.

FIG. 10 is a representation of a mapped machine readable document and its corresponding list having color tint indicators.

FIG. 11 is a representation of a mapped machine readable document and its corresponding list having color tint indicators.

FIG. 12 is a representation of a mapped machine readable document and its corresponding list having color tint indicators.

FIG. 13 is a representation of a mapped machine readable document and its corresponding list tracking user data manipulation.

FIG. 14 is a representation of multiple mapped machine readable documents and a corresponding list tracking user machine readable document initiation.

FIG. 15 is a flowchart view of an embodiment of the process of the present invention.

### DETAILED DESCRIPTION

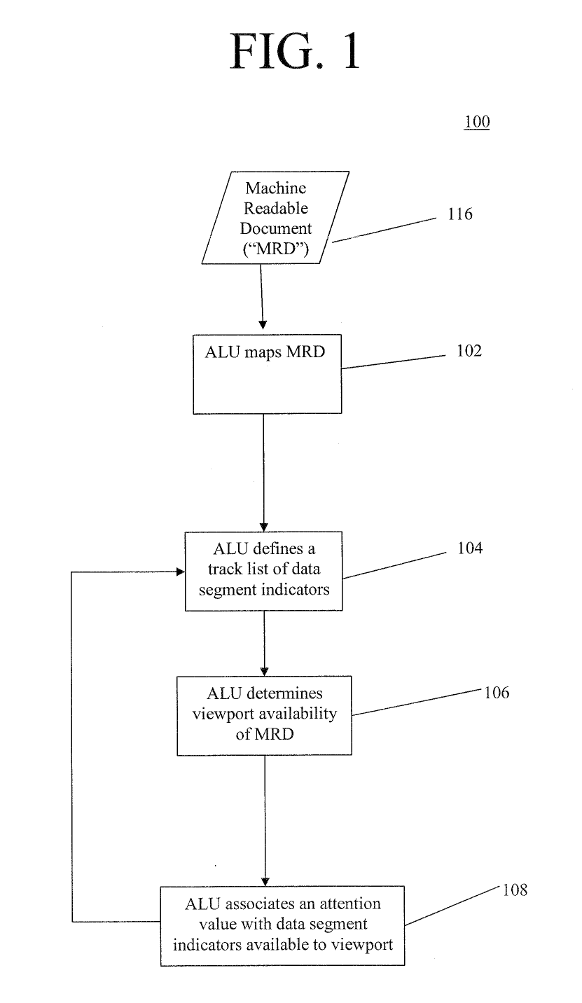

Referring first to FIG. 1, a basic embodiment of the process 100 for tracking document exposure is shown. The document exposure tracking process 100 accepts a machine readable document 116 as initial input. A machine readable document 116 is a representation of a document, together with its associated media (graphics, formatting, etc) as stored in a computer system, transmitted across a network, or stored on digital media. Examples of machine readable documents include ASCII text files, HTML web files, MICROSOFT WORD format documents, scanned images of book pages, or other document formats adapted to communicate visual information. For the purposes of this disclosure, the term machine readable document further includes a view screen's visual representation of the stored machine readable document.

The document exposure tracking process 100 maps 102 the machine readable document into finite data segments. As part of the mapping 102 step, the machine readable document 116 is examined to determine finite data segments therein. Data segments of machine readable documents include any divisible portion of a document that can be apportioned into distinct lexical or special regions. Examples of preferred finite data segments include words, sentences, paragraphs, sections, chapters, titles, or any other grammatical/literary division; graphics; audio files; and video files. The data segment could also be defined relative to the portion of a document represented in some region of a raster rendering; e.g. that section of a document rendered between document scan lines of the document rendering.

The division of a document into lexically meaningful data segments is well studied in the field. For a structured document, such as HTML, segmentation can be performed trivially using markup such as paragraph or document section markers. For unstructured text documents, or for more detailed segmentation within structured documents various techniques could be used. As an example, punctuation could be used to differentiate paragraphs into sentences. Even more simply, a document could be segmented every certain number of words.

After mapping 102 the machine readable document into finite data segments, a track list is defined 104. The track list includes data segment indicators. A data segment indicator is a record of the location of a data segment within the machine readable document. It is preferred that the track list include one data segment indicator that corresponds to each data segment mapped; however, under appropriate circumstances it may be advantageous to include less data segment indicators than discernable data segments, and vice versa. An example of a situation in which a track list may include fewer data segment indicators than data segments includes machine readable documents having royalty-bearing portions intermingled with public domain or free portions.

Although the present invention applies to machine readable documents that fit in their entirety into a view port, the present invention particularly applies to machine readable documents contemplated to be truncated to fit within the view port of the intended user. A truncated document is a document that in its intended, readable state occupies dimensions greater than view port of an intended user, i.e. a superdimensional document. Rather than shrinking the document to allow the document to occupy a view port in its entirety, the document instead retains an easily legible size but only a portion of that document is displayed within the view port. An example of a superdimensional document frequently truncated includes large html web pages, which must be scrolled (either horizontally or vertically) to be viewed in their entirety.

As machine readable documents larger than a view port are truncated to fit within the view port, the process 100 determines 106 the portion of the machine readable document available to the view port. This portion may either the entire machine readable document or a subdivision of that machine readable document. The view port is the area of a representation of a rendered document. In the most common case, this could be a rectangular area of a 2-dimensional raster image which contains a rendering of a document's text. The view port is defined by view port parameters. In an exemplary case the view port parameters may include two numbers which measure the offset into a 2D raster image of the top left-hand corner of a rectangular view port, and two additional numbers which measure the width and height in pixels of the view port into the raster. However, view port parameters may also be measured relative to positions within a document, such as the view of a particular paragraph, instead of being indexed into a particular raster rendering of that document.

Upon determining 106 the portion of the machine readable document available to the view port, the process 100 then analyzes the data segments within the view port and associates 108 those data segments with their respective data segment indicators. The data segment indicators corresponding to the data segments within the view port then receive an attention value. The attention value may be any alpha numeric or symbolic device capable of recording a user's passive or active action with the data segments within the view port. Passive actions include activities, such as reading, that do not involve interactions with data segments. Active actions include higher level activities in which the user manipulates data, such as copying-and-pasting data.

The attention value of the present invention is a value that quantifies the exposure of the machine readable document on the view port of a user. The preferred means for quantifying document exposure includes tracking the data segments available to the view port as a function of time. In instances where multiple view ports are open within a view screen, the present invention may further consider the area of each view port in relation to the area of the view screen as an attention value factor. Due to its inherent accuracy, a preferred means of tracking document exposure as a function of time includes tracking the data segments available to the view port per frame. Current computer screens possess a frame rate of 24-100 frames per second. It is preferred that the arithmetic logic unit update the data segment indicators of the track list after each frame of the view screen expires from the view screen.

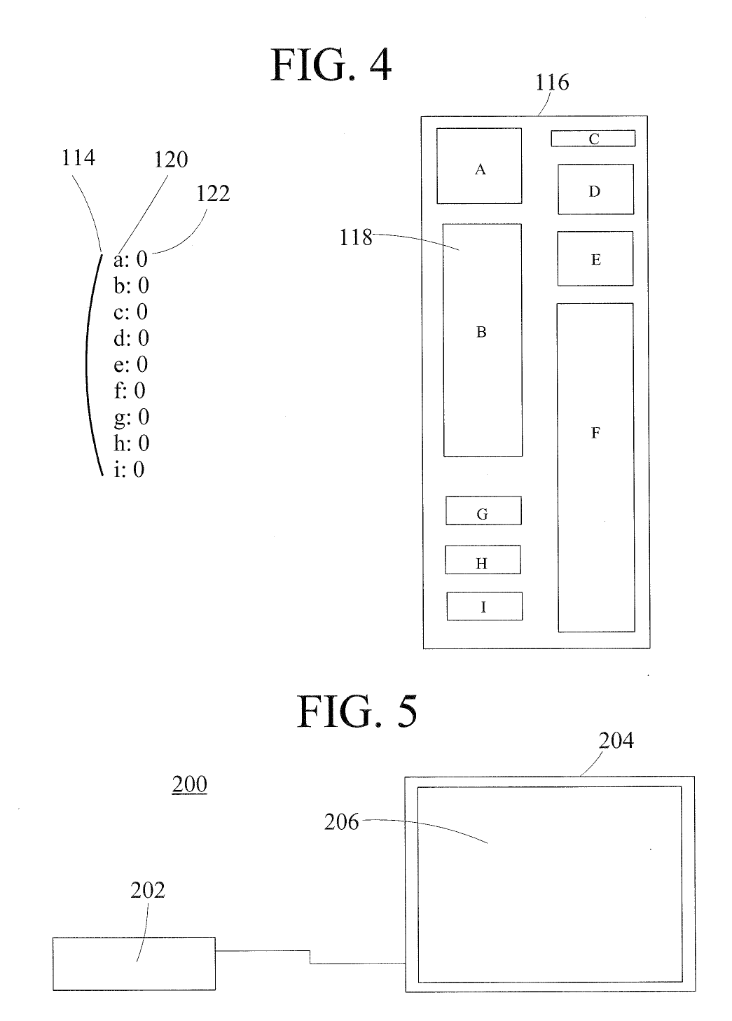

FIG. 4 depicts a representation of an initialized track list 114 and an example of a mapped machine readable document 116. The machine readable document 116 is divided into data segments 118 representing divisible portions of the machine readable document. In the initialized list 114, it is preferred that the track list 114 include the data segment indicator 120 paired with a time indicator 122 as a version of the attention measure.

As FIG. 5 shows, an arithmetic logic unit, e.g. a computer or some other data processor, transmits the machine readable document (not shown) to a display device 204, e.g. a computer monitor. The display device 204 includes a view screen 206 adapted to display information.

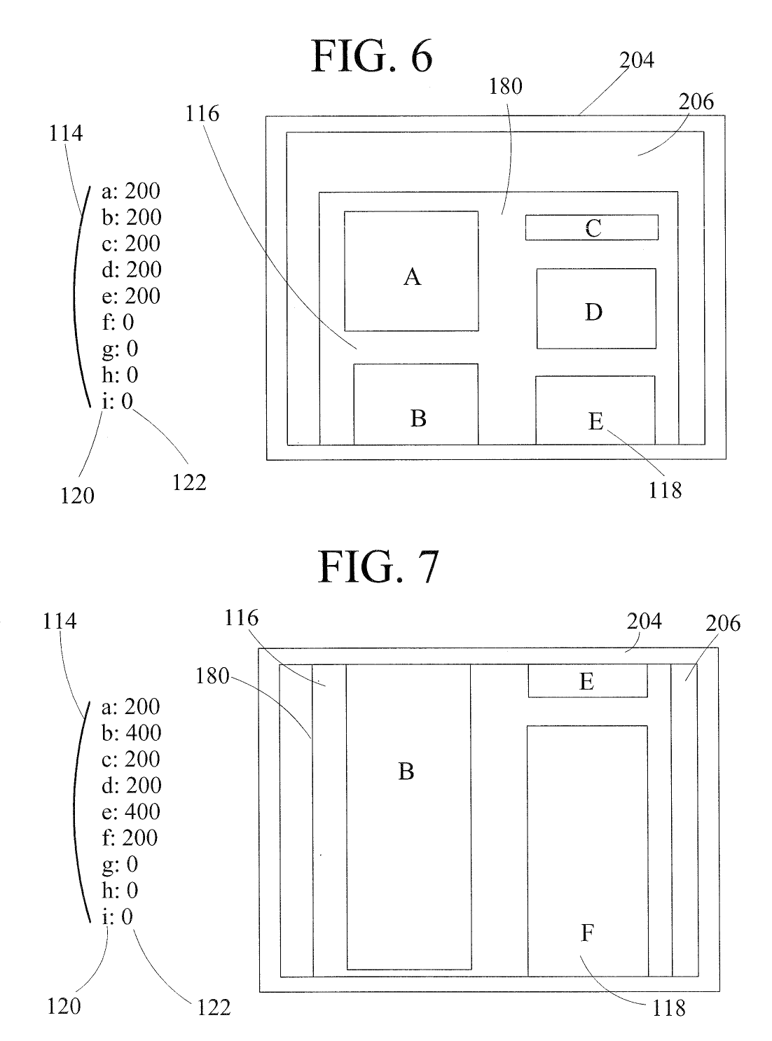

Turning now to FIG. 6, a portion of the machine readable document 116 from FIG. 4 is displayed within the view port 180. The data segments 118 include portions of the machine readable document 116 corresponding to portions A, B, C, D, and E. The attention value is updated according to frame rate, and in this example the content of the view port 180 has been viewed for four seconds on a view screen 206 having a frame rate of fifty frames per second. Accordingly, the track list 114 has been updated according to the preferred document exposure tracking means, i.e. once per existence of each data segment 118 within the view port 180. The track list 114 has been updated to include a count of ‘200’ to correspond to the presence of each data segment 118 within the view port for the given period of time.

Turning now to FIG. 7, a continuation of the example of FIG. 6, a different portion of the machine readable document 116 is displayed within the view port 180. Now, a new set of data segments 118 is available in the view port 180, and the track list 114 is updated accordingly. The data segments 118 include portions of the machine readable document 116 corresponding to portions B, E, and F. The attention value is updated according to frame rate, and in this continuing example the contents of the view port have been viewed for four seconds on a view screen 206 having a frame rate of fifty frames per second. The respective time indicators 122 are updated accordingly. Thus, the data segments available to the view port 180 in FIG. 7, but not FIG. 6 include a time indicator value of ‘200;’ the data segments available to the view port 180 in FIG. 7 and FIG. 6 include a time indicator value of ‘400;’ and the data segments available to the view port 180 in neither FIG. 7 nor FIG. 6 retain their time indicator value of ‘0.’

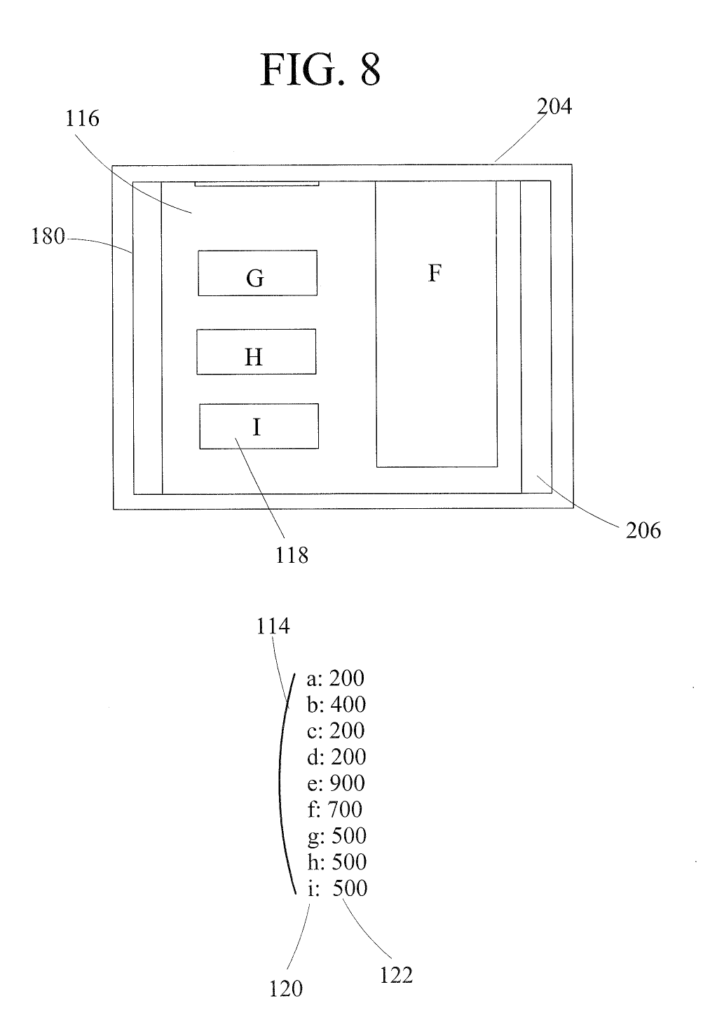

Turning now to FIG. 8, a continuation of the example of FIGS. 6 & 7, a still different portion of the machine readable document 116 is displayed within the view port. Now, a new set of data segments 118 is available in the view port 180, and the track list 114 is updated accordingly. The data segments 118 include portions of the machine readable document 116 corresponding to portions F, G, H, and I. The attention value is updated according to frame rate, and in this continued example the contents of the view port 180 have been viewed for ten seconds on the view screen 206 having a frame rate of fifty frames per second. The respective time indicators 122 are updated accordingly. Thus, the data segments available to the view port in FIG. 8, but not FIGS. 6 and 7 include a time indicator value of ‘500;’ the data segments available to the view port in FIGS. 6-8 include a time indicator value of ‘900;’ the data segments available to the view port in FIG. 7, but not FIGS. 6 and 8 include a time indicator value of ‘200;’ the data segments available to the view port in FIG. 6, but not FIGS. 7 and 8 include a time indicator value of ‘200;’ the data segments available to the view port in FIGS. 7 and 8, but not FIG. 6 include a time indicator value of ‘700;’ and the data segments available to the view port in FIGS. 5 and 6, but not FIG. 8 include a time indicator value of ‘400;’

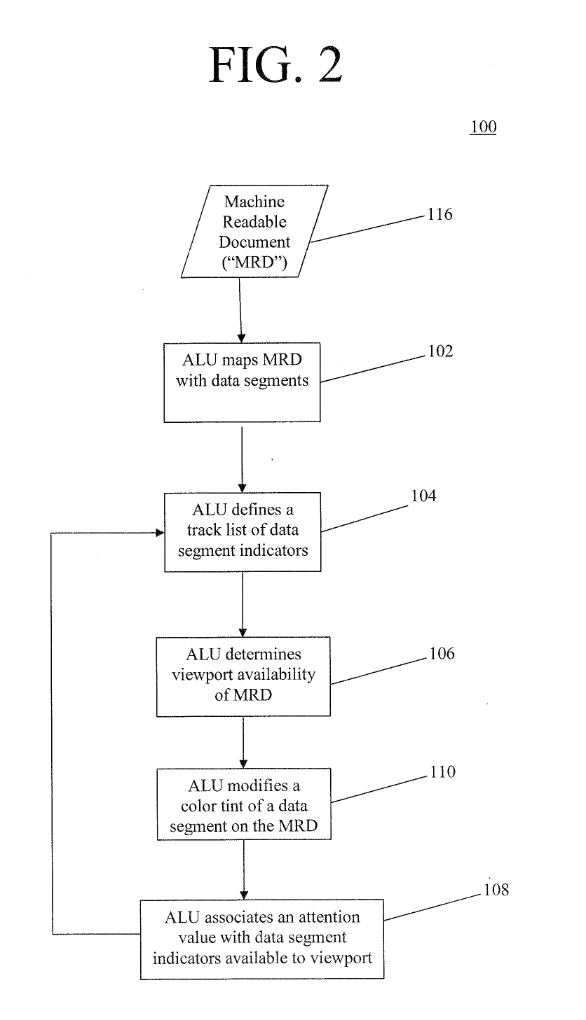

Returning to FIG. 1, preferred embodiments of the process 100 of the present invention will repeat the track list defining step 104 through the association step 108 until the user ceases to view the machine readable document in the view port. FIG. 2 depicts an embodiment of the document exposure tracking process 100 adapted to modify a visual representation of the machine readable document 116 in response to an attention value within the track list. The preferred logic steps of the visual modification embodiment of the document exposure tracking process 100 includes the process of FIG. 1 further comprising the step of modifying 110 a color tint of a data segment within the machine readable document.

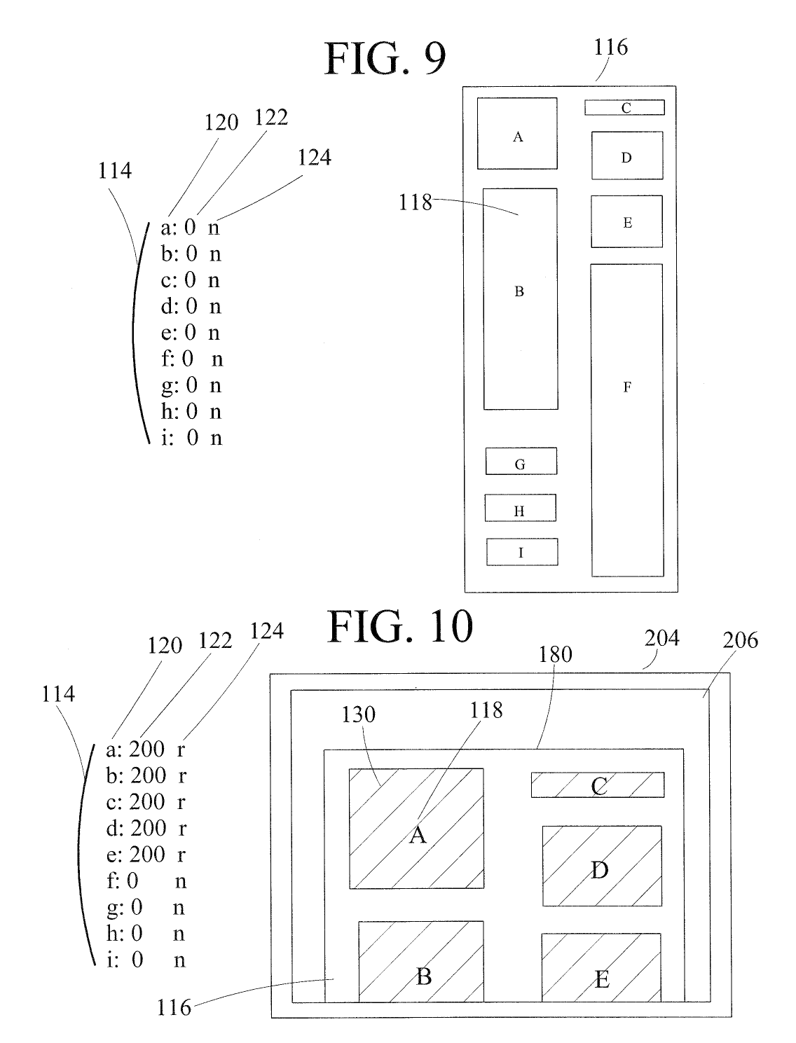

FIGS. 9-12 depict a representation of the preferred process for modifying 110 a color tint of a data segment within the machine readable document. FIG. 9 depicts a representation of an initialized track list 114 and an example of a mapped machine readable document 116. The machine readable document 116 is divided into data segments 118 representing divisible portions of the machine readable document. In the initialized track list 114, it is preferred that the track list 114 include the data segment indicator 120 paired with a time indicator 122 as a version of the attention value and a tint indicator 124 as a version of the attention value. The tint indicator 124 is a place value that accepts a value corresponding to a color having as a destination a data segment of 118 of the machine readable document 116. In the current value of ‘n,’ the tint indicator 124 is set to null.

Turning now to FIG. 10 a portion of the machine readable document 116 is displayed within the view port 180. The data segments 118 include portions of the machine readable document 116 corresponding to portions A, B, C, D, and E. In the example of FIG. 10, the attention value is updated according to frame rate, and in the present example the contents of the view port 180 has been viewed for four seconds on a view screen 206 having a frame rate of fifty frames per second. Accordingly, the track list 114 has been updated according to the preferred document exposure tracking means, i.e. once per existence of each data segment 118 within the view port. The track list 114 has been updated to include a count of “200” to correspond to the presence of each data segment 118 within the view port 180 for the given period of time.

In addition to updating the time indicator 122, the tint indicator 124 has been updated to reflect the attention received by each of the data segments, A-E. In the example of FIG. 10, the four seconds of attention has corresponded to a tint indicator or ‘r,’ perhaps equating to a red tint 130. It is preferred that the modification of a visual representation of the machine readable document 116 occur dynamically, i.e. while the machine readable document 116 is in use. Other embodiments of the present invention may retain the tint indicator values for future representations of the machine readable document, e.g. a print task or graph related to use of the machine readable document—while, or rather than, dynamically update the machine readable document.

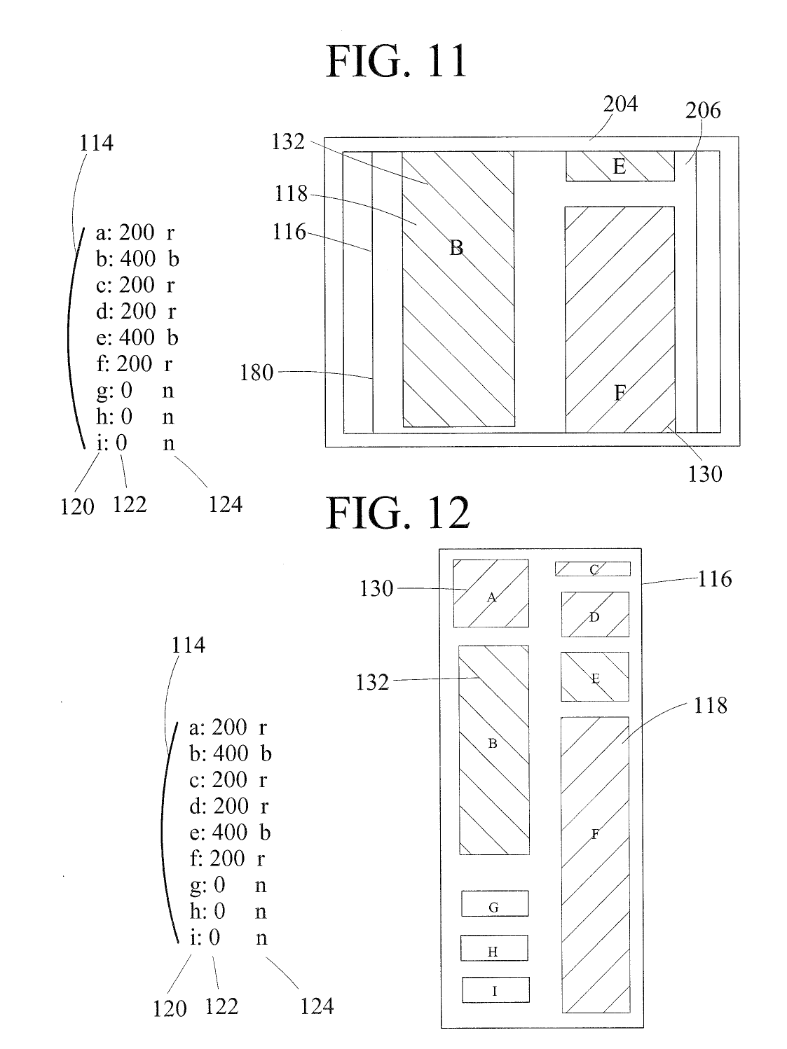

As FIG. 11, a continuation of the example of FIG. 10, shows, it is preferred that the process of the present invention include multiple levels of tinting: e.g. multiple contrasts of the same color, multiple colors, or multiple contrasts of multiple colors. In FIG. 11 a portion of the machine readable document 116 is displayed within the view port 180. The data segments 118 include portions of the machine readable document 116 corresponding to portions B, E, and F. In the example of FIG. 11, the attention value is updated according to frame rate, and the present example the content of the view port 180 has been viewed for four seconds on a computer monitor 204 having a frame rate of fifty frames per second. The respective time indicators 122 are updated accordingly. Thus, the data segments available to the view port in FIG. 10, but not FIG. 11 include a time indicator value of ‘200;’ the data segments available to the view port 180 in FIG. 11 and FIG. 10 include a time indicator value of ‘400;’ and the data segments available to the view port in neither FIG. 11 nor FIG. 10 retain their time indicator value of ‘0.’

The document can be rendered into an intermediate representation in a number of ways. If the document is directly rendered into a raster image, than a list of rectangular areas which correspond to the document segments can be maintained. The tinting would be implemented by compositing a blended tint overlay on the displayed segments during the final rendering to the screen. Alternatively, the raster image itself could be modified.

The attention value corresponding to a time indicator value of ‘400’ equates to a tint indicator 124 value of ‘b,’ perhaps representing a blue tint 132. As FIG. 12 shows, the machine readable document has been updated to include color tinting 130, 132 relative to the attention received by the specific data segments. Data segments A, C, D, and F each received four seconds of attention and received a red color tint 130; data segments B and E each received eight second of attention and received a blue color tint 132; data segments G, H, and I received no attention and retained their original tint.

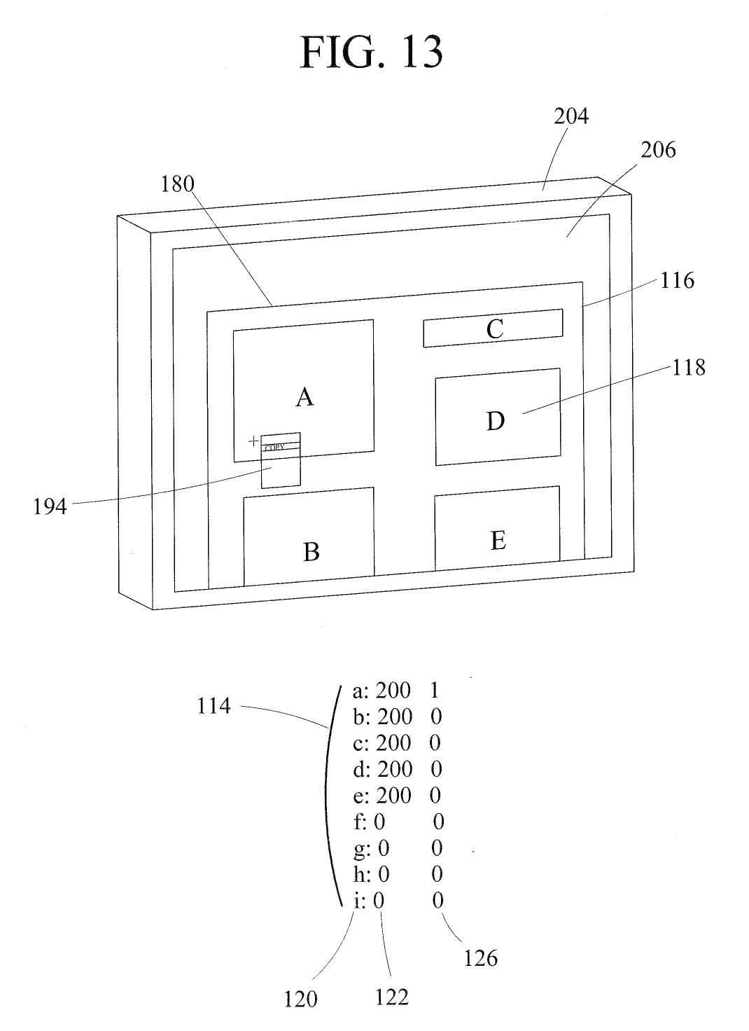

Attention values may include activities beyond merely reading and observing visual data. As FIG. 13 shows, the attention measures may further track active actions such as data manipulation 194. In the data manipulation of FIG. 13, a user is copying a section of data to transfer to a local storage medium, either independently or via another machine readable document. A common example of such a transfer may be copying from an .html web page to paste into a MICROSOFT WORD document. The track list 114 may include a manipulation indicator 126 that tracks a user's activities. Here the manipulation indicator is tracking the user's copy function.

A preferred attention value tracks the origin of interactions between a document viewer and a document. The attention value may track attention by workstation (e.g. the specific computer from which a document was viewed), by user (e.g. the specific user viewing the document), or some other user-related factor. In tracking the origin of a particular user, the attention value may assign to each user a specific color, which is then tinted based on the attention from that particular user. Further versions of the user-specific attention value may track user-specific active actions by a color distinct to that user.

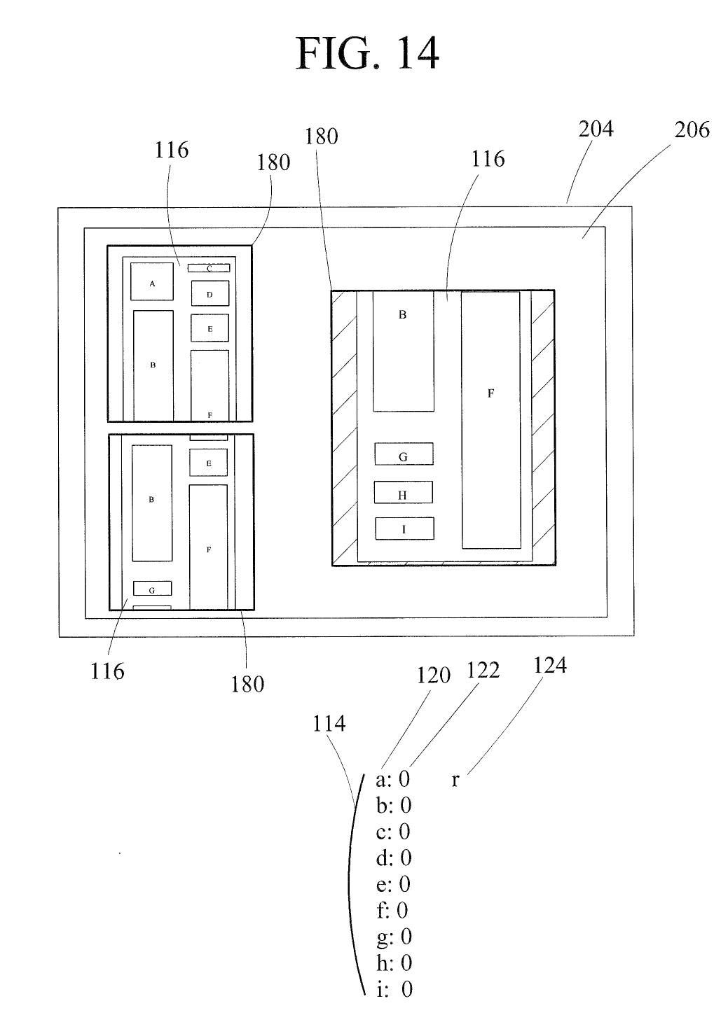

As FIG. 14 shows, the attention value may be weighted in relation to the area of the machine readable document 116, or the view port 180 through which it is displayed, available to the entirety of the view screen 206. This consideration particularly applies in situations where the multiple view ports 180 are splashed across the view screen 206. It is preferred that such a weighted consideration be a direct proportion between the area of the particular view port and the area of the view screen. In the example machine readable documents of FIG. 14, it would be preferred that at each frame rate measurement that the document segments of the larger machine readable document would have a greater track value per frame than the two smaller machine readable documents.

In instances where multiple machine readable documents may be present within a view screen, it is preferred that multiple track lists are used to track user interactions. Alternatively, a single track list may be arranged to track multiple documents. It is most preferred that there be one track list per view port, but such is not necessary. In multiple user embodiments of the present invention, it is particularly advantageous to utilize a global tint indicator 124. A global tint indicator 124 is a tracking device incorporated within a track list 114 that records which users have accessed a particular machine readable document. In tracking identity, the global tint indicator 124 may associate a color with a particular user; in the example of FIG. 14, red ‘r’ has been associated with a user of one of the machine readable documents. In recording a color tint by user, it is preferred that the present invention tint the view port, the machine readable document, or merely the data segments viewed by that particular user. In tracking user status, the present invention may track as an attention value the source of a user's interaction by either the physical source (e.g. workstation or television), by a log indicator (e.g. by password-protected log in), or any other method for determining a user or user location. The preferred means for tracking the user interaction involves modifying the track list to include a tint value as the view port is initiated to display the machine readable document.

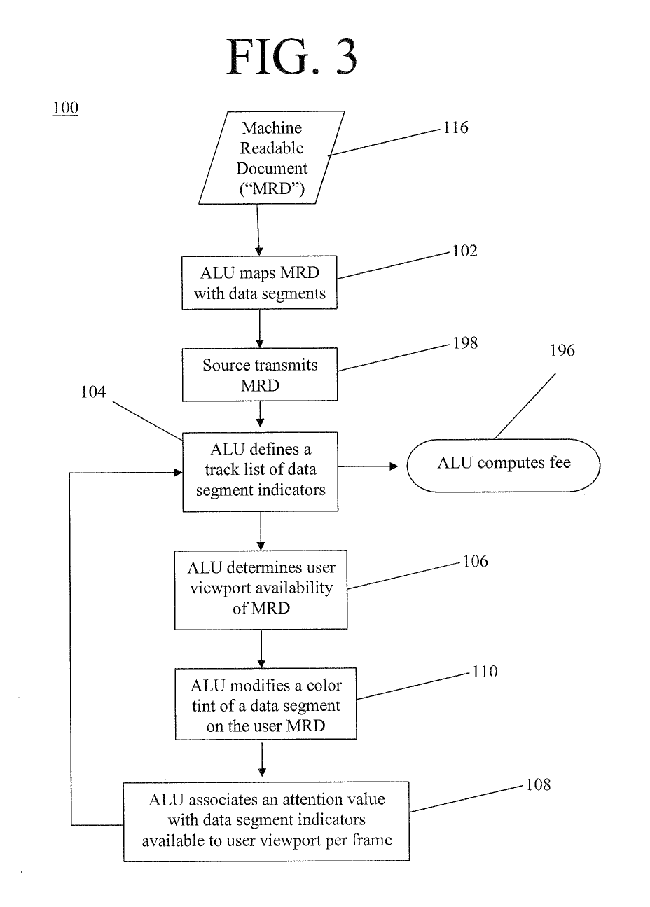

As FIG. 3 shows, the process of the present invention may further include the steps of transmitting 198 a machine readable document and computing 196 a fee based on an attention measure retained in the track list. The transmission 198 of a machine readable document may occur from any non-local storage medium not in physical proximity to a display device. An example of a transmission of the present invention includes sending a machine readable document via telephone lines or television cable. Subscriber services such as databases, news outlets, and journals may find advantage in charging users by their examination of certain portions of documents rather than charging for the use of a document in its entirety, from which the user gleans necessary material.

One use of the present invention is for publisher royalty attribution and invoicing. The track lists are generated 104 according to the process of the present invention and then measure the amount of “attention” paid to a particular document by the reader and update an attention value of the track list accordingly. This measure of attention can be used by publishers for invoicing royalty payments from the individual user or an online content provider.

A can be any entity interested in searching and viewing documents. It is preferred that the user have installed on his local computer a document viewing system capable of accepting of portion of the process 100 of the present invention. A content provider provides access for the user to a library of machine readable document files over a computer network, via the document viewing system. The library of documents includes documents owned by various copyright holders seeking royalties for the use of their work. A central revenue server collects exposure information from the document viewing system, and uses the information to maintain an account for each copyright holder.

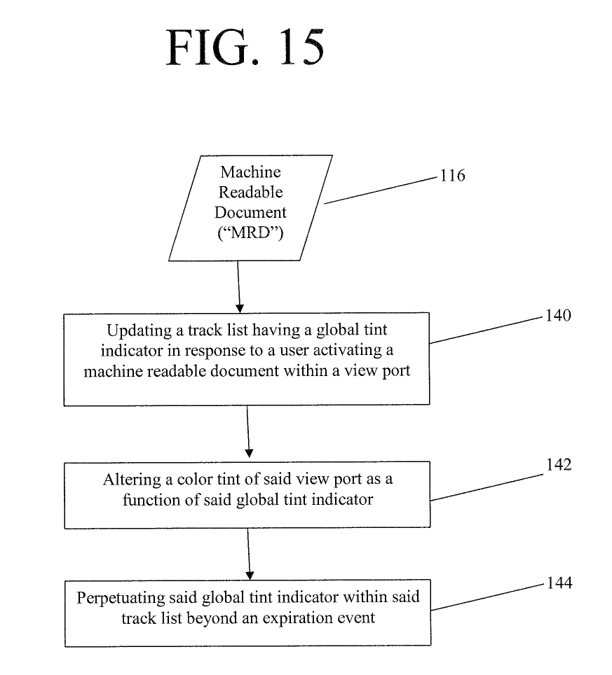

As FIG. 15 illustrates, the present invention further includes activating a machine readable document 116 in the view port of a view screen. The track list includes a global tint indicator which is updated 140 in response to a user activating a machine readable document with the view port. As a function of the global tint indicator, the color tint of the view port alters. This view port color tint alteration may occur dynamically on the screen of the user or dynamically on the screen of a supervisor utilizing color schemes to contemporaneously view the present pursuits of employees working in a jointly shared document workspace. A jointly shared document workspace is a workspace comprising many multiple documents into which multiple users may access simultaneously. It is preferred that the track list perpetuate 144 the global tint indicator for a machine readable document beyond an expiration event. An expiration event occurs when the machine readable document has been removed from the sight of a user, which may include deactivation (i.e. exiting), repositioning the machine readable document such that it no longer appears in the view screen, and the like. When the global tint indicator survives the expiration event, a supervisor may view the total progress of one or more users in a given amount of time.

Returning to FIG. 4, an embodiment of the system 200 of the present invention is shown. The ALU 202 initializes the view port for a machine readable document and processes the track list to store machine readable document information availability. The document information availability is a version of the attention value that tracks the presence of a machine readable document within a view port, rather than the specific data segments of the machine readable document. As the machine readable document is available to the view port, the availability (i.e. presence) of the machine readable document on a view screen 206 is tracked. Upon reaching a certain value, the track list is updated by exposure transmitter of the arithmetic logic unit with a color tint value specific to a particular user, i.e. the one that activated the machine readable document in the view port. According to a value in the track list the view port, or some portion thereof, is altered by color tint. By altering the tint of the view port, it is meant that the view port, any raster or vector rendering displayed therein, or any portion of a raster or vector rendering displayed therein may be altered in color tint. The alteration may appear dynamically on the computer of the user or the supervisor of the user. In relatively small scale uses of the present invention it is preferred that a unique color tint be assigned to each user of the system of the present invention.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A process for tracking document exposure, said process comprising:
mapping into finite data segments a superdimensional machine readable document adapted to communicate information;
defining a list of data segment indicators corresponding to said data segments;
determining a portion of said machine readable document truncated to a occupy view port; and
associating an attention value with at least one of said data segment indicators corresponding to the presence of at least one of said data segments available in to said view port.

2. The process of claim 1 wherein said associating step includes altering said attention value of at least one of said data segment indicators as a function of time.

3. The process of claim 1 wherein said associating step includes altering said attention value of at least one of said data segment indicators in response to data segment manipulation.

4. The process of claim 3 wherein said associating step includes altering said attention value of at least one of said data segment indicators in response to a regional data transfer operation.

5. The process of claim 1 further comprising the step of charging a currency value as a function of at least one of said attention values.

6. The process of claim 1 further comprising the step of modifying a visual representation of said information of said machine readable document in response to at least one attention value.

7. The process of claim 6 wherein said modifying step includes modifying a color tint of said data segments of said machine readable document in response to at least one attention value.

8. The process of claim 7 further comprising the step of associating a tint value indicator with at least one of said data segment indicators.

9. The process of claim 1 further comprising the step of updating at least one of said attention values as a function of time.

10. The process of claim 9 wherein said updating step includes updating at least one of said attention values as a function of a frame rate.

11. The process of claim 10 wherein said modifying step includes modifying a color tint of said data segments of said machine readable document in response to at least one attention value.

12. The process of claim 1 further comprising the step of updating at least one of said attention values in response to view port initiation.

13. The process of claim 9 wherein said updating step includes updating at least one of said attention values as a function of a frame rate.

14. The process of claim 1 wherein said associating step includes associating an attention value with at least one of said data segment indicators corresponding to the presence of at least one of said data segments at least partially available in said view port.

15. The process of claim 14 wherein said associating step includes associating an attention value with at least one of said data segment indicators corresponding to the presence of at least one of said data segments available in its entirety in said view port.

16. A process for tracking document exposure, said process comprising:
transmitting a superdimensional machine readable document adapted to communicate information;
mapping said machine readable document into finite data segments;
initiating a list comprising: data segment indicators corresponding to said data segments, and a null attention value corresponding to each data segment indicator;
determining a portion of said machine readable document truncated to occupy a view port;
and
updating the value of said attention value with at least one of said data segment indicators corresponding to the presence of at least one of said data segments available in said view port.

17. The process of claim 16 wherein said initiating step further comprises initiating a list with a color tint indicator preset to neutral; and said updating step further comprises updating the color tint indicator corresponding to the presence of at least one of said data segments available in said view port.

18. The process of claim 17 wherein said updating step includes altering said attention value of at least one of said data segment indicators as a function of time.

19. The process of claim 17 wherein said associating step includes altering said attention value of at least one of said data segment indicators in response to data segment manipulation.

20. A document exposure tracking system comprising:
a display device having a view screen; and
an arithmetic logic unit, in signaled communication with said display device, comprising:
a mapping function adapted to map into finite data segments a superdimensional machine readable document for communicating information;
a list having data segment indicators corresponding to said data segments;
a frame buffer analyzer adapted to determine a portion of said machine readable document available to said view port; and
an exposure transmitter adapted to associate an attention value with at least one of said data segment indicators corresponding to the presence of at least one of said data segments available in said view port.

21. A document exposure tracking system comprising:
a display device having a view screen; and
an arithmetic logic unit, in signaled communication with said display device, comprising:
a view port;
a machine readable document adapted to be displayed within said view port;
a track list for storing machine readable document availability information;
a global tint indicator, within said track list, adapted to update in response to a user initiated machine readable document activation within said view port; and
an exposure transmitter of said arithmetic logic unit, said exposure transmitter adapted to alter a color tint of said view port as a function of said global tint indicator.

22. A process for tracking document exposure, said process comprising:
activating a machine readable document within a view port;
updating a track list having a global tint indicator in response to a user activating a machine readable document within a view port; and
altering a color tint of said view port as a function of said global tint indicator.

23. The process of claim 22 further comprising perpetuating said global tint indicator within said track list beyond an expiration event.
